(19) United States
(12) Patent Application Publication
(10) Pub. No.: US 2006/0091781 A1
(43) Pub. Date: May 4, 2006

(54) Image display device

(75) Inventors: Yuuji Haraguchi, Konosu-shi (JP); Masataka Tsunemi, Isesaki-shi (JP); Hiroaki Ibuki, Ageo-shi (JP); Hirotaka Murata, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/305,215

(22) Filed: Dec. 19, 2005

Related U.S. Application Data
(63) Continuation of application No. PCT/JP04/08843, filed on Jun. 17, 2004.

(30) Foreign Application Priority Data
Jun. 19, 2003 (JP) 2003-175053

(51) Int. Cl. H01J 1/62; H01J 63/04

(52) U.S. Cl. 313/495; 313/311; 313/497

(57) ABSTRACT

A front substrate of an image display device comprises a phosphor screen, a metal back layer lapped on the phosphor screen and having a plurality of divided regions spaced from one another, a common electrode which applies voltage to the metal back layer, and a plurality of connecting resistors which connect the common electrode and the plurality of divided regions of the metal back layer. A plurality of electron emitting elements which emit electrons toward the phosphor screen are arranged on a rear substrate opposed to the front substrate. The common electrode is covered by a coat member having a sheet resistance higher than that of the connecting resistors.

### CROSS-REFERENCE TO RELATED APPLICATIONS

This is a Continuation Application of PCT Application No. PCT/JP2004/008843, filed Jun. 17, 2004, which was published under PCT Article 21(2) in Japanese.

This application is based upon and claims the benefit of priority from prior Japanese Patent Application No. 2003-175053, filed Jun. 19, 2003, the entire contents of which are incorporated herein by reference.

### BACKGROUND OF THE INVENTION

1. Field of the Invention

The present invention relates to an image display device, and more particularly, to a flat image display device using electron emitting elements.

2. Description of the Related Art

In recent years, various flat image display devices have been developed as next generation image display devices in which a large number of electron emitting elements are arranged side by side and opposed to a phosphor screen. While there are various types of electron emitting elements, all of them basically utilize field emission. Display devices that use these electron emitting elements are generally called field emission displays (FED's). Among the FED's, a display device that uses surface-conduction electron emitting elements is also called a surface-conduction electron emission display (SED). In this specification, however, the term “FED” is used as a generic name for devices including the SED.

In general, an FED comprises a front substrate and a rear substrate that are opposed to each other across a predetermined gap. These substrates have their respective peripheral portions joined together by a sidewall in the shape of a rectangular frame, thereby constituting a vacuum envelope. The interior of the vacuum envelope is kept at a high vacuum such that the degree of vacuum is about 10⁻⁴ Pa or below. In order to support an atmospheric load that acts on the rear substrate and the front substrate, a plurality of support members are located between these substrates.

A phosphor screen that includes red, blue, and green phosphor layers is formed on the inner surface of the front substrate, and a large number of electron emitting elements that emit electrons for exciting the phosphor to luminescence are provided on the inner surface of the rear substrate. Further, a large number of scan lines and signal lines are formed in a matrix and connected to the electron emitting elements. An anode voltage is applied to the phosphor screen, and electron beams emitted from the electron emitting elements are accelerated by the anode voltage and collide with the phosphor screen, whereupon the phosphor glows and displays an image.

In the FED of this type, the gap between the front substrate and the rear substrate can be set to several millimeters or less. When compared with a cathode-ray tube (CRT) that is used as a display of an existing TV or computer, therefore, the FED can achieve lighter weight and smaller thickness.

In order to obtain practical display characteristics for the FED constructed in this manner, it is necessary to use a phosphor that resembles that of a conventional cathode-ray tube and to use a phosphor screen that is obtained by forming a thin aluminum film called a metal back on the phosphor screen. In this case, the anode voltage to be applied to the phosphor screen should be set to at least several kV, and preferably, to 10 kV or more.

In view of the resolution, the properties of the support members, etc., the gap between the front substrate and the rear substrate cannot be made very wide and should be set to about 1 to 2 mm. In the FED, therefore, a strong electric field is inevitably formed in the narrow gap between the front substrate and the rear substrate, so that electric discharge (dielectric breakdown) between the substrates arises a problem.

If electric discharge occurs, the electron emitting elements, the phosphor screen, or a driver circuit may possibly be broken or degraded. These failures will be referred to collectively as electric discharge damage. Electric discharge that results in these failures is not allowed for products. In order to put the FED into practical use, therefore, it must be constructed so that it can be prevented from being damaged by electric discharge for a long period of time. It is very hard, however, to restrain electric discharge perfectly for a long period of time.

Supposedly, on the other hand, a measure may be taken to restrain the scale-of electric discharge so that the influence of occurrence of electric discharge, if any, on the electron emitting-elements, phosphor screen, and driver circuit is negligible, not to prevent generation of the electric discharge. A technique associated with this idea is disclosed in Jpn. Pat. Appln. KOKAI Publication No. 10-326583, for example. In this technique, a metal back is divided and connected to a common electrode outside a phosphor screen through a resistance member.

Although there is an effect to restrain the scale of electric discharge for electric discharge on the phosphor screen with the divided metal back, according to this technique, however, there is no effect for electric discharge that occurs outside the phosphor screen. If electric discharge that involves the common electrode occurs, in particular, connecting resistors are connected in parallel. Therefore, a phenomenon occurs such that a large electric charge accumulated on the entire phosphor screen flows into an electric discharge point, and the discharge current may possibly increase to tens of amperes or more. Although no electron source is formed in this region, there exist wires that are connected to an electron source. If electric discharge occurs, therefore, voltage of the wires increases, so that a phenomenon inevitably happens in which the electron source or a driver IC is damaged by overvoltage.

### BRIEF SUMMARY OF THE INVENTION

An object of the present invention is to provide an image display device in which generation of electric discharge in a region outside a phosphor screen can be restrained perfectly to inhibit electric discharge damage. Another object of this invention is to provide an image display device capable of increasing an anode voltage or lessening a gap between a front substrate and a rear substrate and enjoying improved characteristics, such as luminance, life, resolution, etc.

In order to achieve the object, an image display device according to an aspect of the invention comprises: a front substrate having a phosphor screen including phosphor layers and a light shielding layer, a metal back layer lapped on the phosphor screen and having a plurality of divided regions spaced from one another, a common electrode which applies voltage to the metal back layer, connecting resistors which connect the common electrode and the plurality of divided regions of the metal back layer, and a coat which has a sheet resistance higher than the sheet resistance of the connecting resistors and covers the common electrode; and a rear substrate opposed to the front substrate and having a plurality of electron emitting elements which emit electrons toward the phosphor screen.

According to another aspect of the invention, there is provided an image display device comprising: a front substrate having a phosphor screen including a phosphor layer and a light shielding layer, a metal back layer lapped on the phosphor screen and having a plurality of divided regions spaced from one another, a common electrode which applies voltage to the metal back layer, and connecting resistors which connect the common electrode and the plurality of divided regions of the metal back layer; a rear substrate opposed to the front substrate and having a plurality of electron emitting elements which emit electrons toward the phosphor screen, a plurality of wires connected to the electron emitting elements, and a coat which covers those ones of the wires which are situated in a region opposite to the common electrode and has a sheet resistance of 1E7 Ω/□ or more.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an FED according to an embodiment of this invention;

FIG. 2 is a sectional view of the FED taken along line II-II of FIG. 1;

FIG. 3 is a plan view showing a phosphor screen and a metal back layer of a front substrate of the FED;

FIG. 4 is a sectional view of the front substrate taken along line IV-IV of FIG. 3;

FIG. 5 is a sectional view of the FED taken along line V-V of FIG. 1;

FIG. 6 is a plan view showing a phosphor screen and a metal back layer of a front substrate of an FED according to a second embodiment of this invention;

FIG. 7 is a sectional view showing the FED according to the second embodiment of this invention;

FIG. 8 is a sectional view showing an FED according to a third embodiment of this invention; and

FIG. 9 is a plan view showing a front substrate of an FED according to a further embodiment of this invention.

### DETAILED DESCRIPTION OF THE INVENTION

An embodiment of an FED to which this invention is applied will now be described in detail with reference to the drawings.

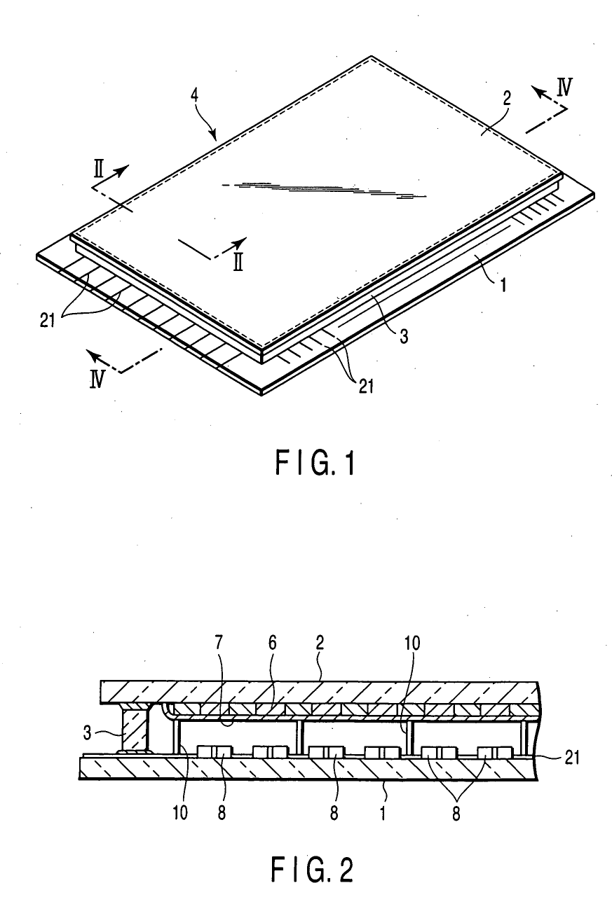

As shown in FIGS. 1 and 2, this FED comprises a front substrate 2 and a rear substrate 1, and these substrates are formed of a rectangular glass plate each and opposed to each other with a gap of 1 to 2 mm between them. The front substrate 2 and the rear substrate 1 have their respective peripheral edge portions joined together by a sidewall 3 in the form of a rectangular frame, thereby forming a flat, rectangular vacuum envelope 4 of which the interior is kept at a high vacuum of about 10⁻⁴ Pa or less.

A phosphor screen 6 is formed on the inner surface of the front substrate 2. As mentioned later, the phosphor screen 6 has phosphor layers, which glow red, green, and blue, individually, and a matrix-structure light shielding layer. Formed on the phosphor screen 6 is a metal back layer 7 that serves as an anode layer. During display operation, a given anode voltage is applied to the metal back layer 7.

Provided on the inner surface of the rear substrate 1 are a large number of electron emitting elements 8, which emit electron beams that excite the phosphor layers. These electron emitting elements 8 are arranged in a plurality of columns and a plurality of rows corresponding to individual pixels. The electron emitting elements 8 are driven by wires 21 that are arranged in a matrix.

A large number of plate-like or columnar support members 10 are located between the rear substrate 1 and the front substrate 2. They serve to counterbalance the atmospheric pressure that acts on these substrates.

An anode voltage is applied to the phosphor screen 6 through the metal back layer 7, and electron beams emitted from the electron emitting elements 8 are accelerated by the anode voltage and collide with the phosphor screen 6. Thereupon, the corresponding phosphor layers glow and display an image.

The following is a detailed description of the phosphor screen 6 and the metal back layer 7 of the FED described above. Although the term “metal back layer” is used in the present invention, this layer is not limited to metal, and various materials may be used for it. In the present invention, however, the term “metal back layer” is used for the sake of convenience.

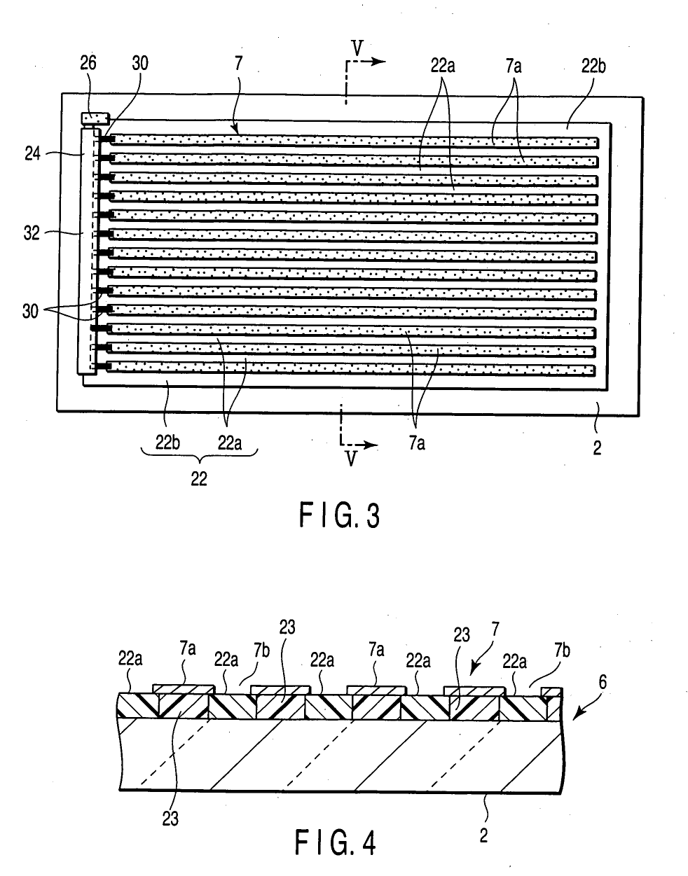

As shown in FIGS. 3 to 5, the phosphor screen 6 that is provided on the inner surface of the front substrate 2 has a light shielding layer 22. The light shielding layer 22 has a large number of stripe portions 22a arranged parallel to one another with predetermined gaps between them and a rectangular frame portion 22b that extends along the peripheral edges of the phosphor screen 6. The phosphor screen 6 has a large number of stripe-shaped phosphor layers 23 that glow red, blue, and green, individually. These phosphor layers 23 are formed individually between the stripe portions 22a of the light shielding layer 22.

The metal back layer 7 on the phosphor screen 6 is formed as a split metal back layer. Specifically, the metal back layer 7 is divided into a large number of divided regions 7a. Each divided region 7a is formed having the shape of an elongate stripe corresponding to each phosphor layer 23.

The metal back layer 7 is formed by thin-film processing such as vapor deposition. Since the phosphor screen 6 is rugged, a mirror surface cannot be formed if the metal back layer 7 is formed directly on the phosphor screen 6. Generally known, therefore, is a method in which vapor deposition is performed after a smoothing process is carried out using lacquer or the like. In another available method, a sheet vapor-deposited with aluminum or the like is heat-transferred. In consideration of the transmissibility for electron beams and film strength, the thickness of the metal back layer 7 preferably ranges from about 50 to 200 nm.

In an existing method to divide the metal back layer 7, a member that has a property to sever a thin film is previously located on the light shielding layer 22 in forming the metal back layer 7 on the phosphor screen 6. By doing this, the metal back layer can be divided as it is formed. This method is effective for the case where the metal back layer 7 is formed by the vapor deposition method or the like. In another available dividing method, the metal back layer is severed by heat treatment using a laser or the like or under a physical pressure after the metal back layer is formed in an unsevered state.

A belt-shaped common electrode 24 is formed on the rectangular frame portion 22b of the light shielding layer 22, and a high-voltage supply portion 26 is formed on a part of it. A high voltage is applied to the common electrode 24 by suitable means.

The common electrode 24 is composed of an electrically conductive material. It is formed by screen-printing Ag paste, for example. The divided regions 7a of the metal back layer 7 are connected electrically to the common electrode 24 through connecting resistors 30. This configuration restrains damage that is attributable to electric discharge between the phosphor screen 6 and the rear substrate 1. However, this electric discharge restraint is persistently restricted to the area of the phosphor screen 6, and is not effective for the case where electric discharge is caused between the common electrode 24 and the rear substrate.

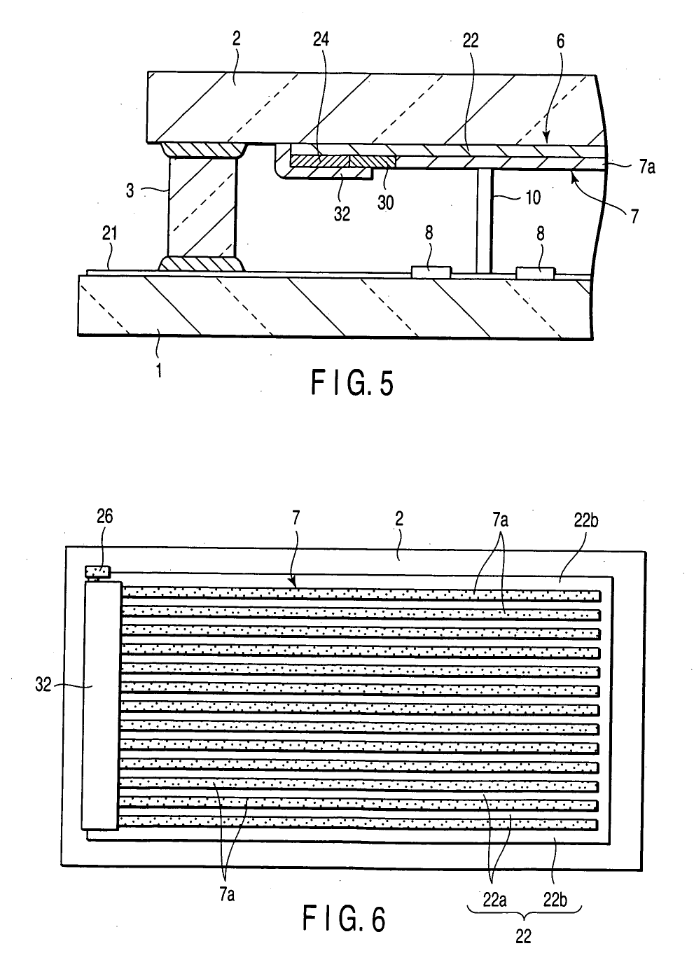

According to the present embodiment, therefore, the common electrode 24 is covered by a high-resistance member or insulating member in case electric discharge is caused between the common electrode and the rear substrate 1. Specifically, as shown in FIGS. 3 and 5, an elongate coat member 32 is provided on the common electrode 24 so as to cover the common electrode 24 entirely. The coat member 32 is provided also partially overlapping the connecting resistors 30. The coat member 32, which serves as a coat, is formed by the screen-printing method, for example. A high-resistance material or insulating material is used for the coat member 32. For example, low-melting glass or low-melting glass with a resistance material dispersed therein may be used.

The sheet resistance of the coat member 32 must be made higher than the sheet resistance of the connecting resistors 30 so that the resistance value setting is not influenced. The sheet resistance of the connecting resistors 30, which has broadness depending on the total design, ranges from about 1E3 to 1E5 Ω/□. Thus, the coat member 32 is formed of a so-called high-resistance film or insulating film.

In general, it is said that electric discharge does not easily occur if a high-resistance coat or insulating coat is provided on the anode side. As a result of an experiment, the inventors hereof ascertained that the presence of the coat can restrain the occurrence of electric discharge. When there was no coat, an average of discharge voltages of the FED was 12 kV. When a high-resistance film of 4E8 Ω/□ sheet resistance, obtained by dispersing resistor material powder in low-melting glass, was formed as the coat member 32 by the screen-printing method, the average discharge voltage was 16 kV. When the insulating coat was formed from low-melting glass only, the average discharge voltage was 17 kV. Depending on the anode voltage setting, no electric discharge can occur in practice.

A mechanism for obtaining this effect has not been thoroughly investigated yet. However, most-electric discharges in objective voltage regions of the FED are attributable to particulates. They are supposed to be caused because charge exchange is restrained as the particulates collide with an opposite surface, and therefore, because the process of acceleration of the particulates to start electric discharge is restrained.

According to the FED constructed in this manner, generation of large-scale electric discharge that involves the common electrode 24 can be restrained, so that a phenomenon that electric discharge damage is generated through the wires can be prevented.

The following is a description of an FED according to a second embodiment of this invention. Although only the common electrode has been noted in connection with the first embodiment described above, electric discharge of an unallowable scale may possibly occur also if electric discharge is caused in the connecting resistors 30.

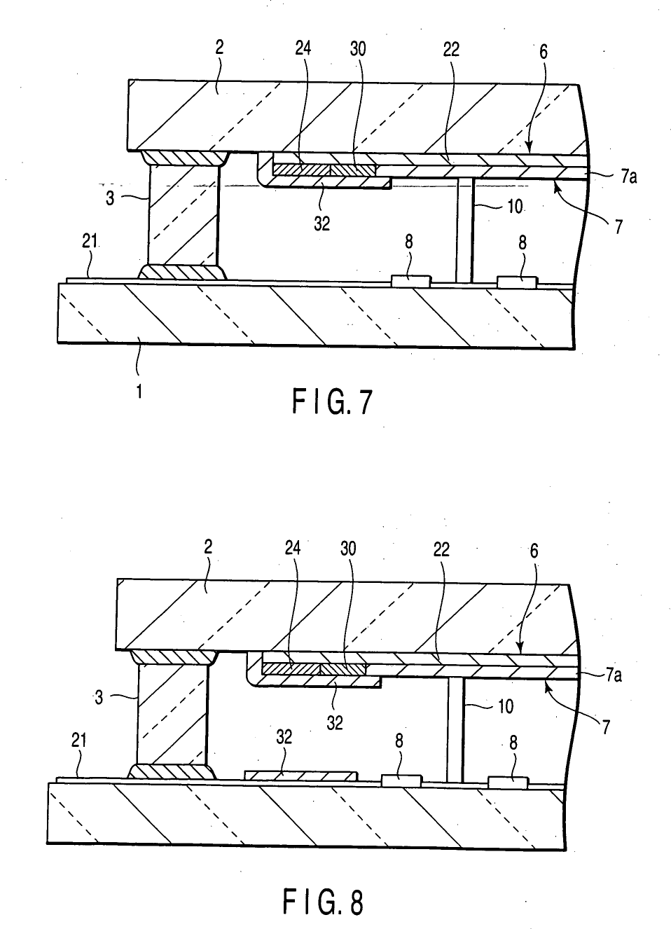

According to the second embodiment, as shown in FIGS. 6 and 7, therefore, a coat member 32 is lapped entirely on a common electrode 24 and connecting resistors 30. The coat member 32 is provided also partially overlapping a front substrate 2 and a metal back layer 7. The coat member 32 is formed by the screen-printing method, for example. With this arrangement, generation of electric discharge can also be entirely restrained in a region outside a phosphor screen 6, and a measure to counter electric discharge more secure than in the first embodiment can be realized.

In the second embodiment, the basic configurations of a vacuum envelope and the like are the same as those of the foregoing first embodiment, so that like reference numerals are used to designate like portions, and a description of those portions is omitted.

The following is a description of an FED according to a third embodiment of this invention. In the third embodiment, as shown in FIG. 8, an insulating coat is also provided on a side of a rear substrate 1. Specifically, a rear-substrate-side coat member 33 covers wires 21 that are situated opposite a common electrode 24 and connecting resistors 30. As a result of an experiment, it was ascertained that the above configuration reduces the occurrence of electric discharge less easy. When a coat member was provided only on a side of a front substrate, the average discharge voltage was 16 kV. When the insulating coat was also formed on the rear substrate 1, on the other hand, the average discharge voltage was 20 kV or more. Although details of this mechanism are also unknown, this is supposed to be attributable to the fact that charge exchange of particulates is additionally restrained, or that a source of electric discharge on the rear substrate side is covered.

The coat member 33 is formed having a width of about 5 to 15 mm. Since leak currents between the wires 21 must be made sufficiently low, the sheet resistance of the coat member 33 should preferably be adjusted to 1E7 Ω/□ or more. Preferably, in practice, the coat member 33 should be formed simultaneously with an interlayer insulating film for the wires 21. In this case, the sheet resistance of the coat member 33 is sufficient.

A better measure to counter electric discharge can be realized by thus providing the coat member 33 at least on the side of the rear substrate 1 in the position where it faces the common electrode 24. Thus, the anode voltage can be made higher, and a gap between the front substrate and the rear substrate can be narrowed, so that characteristics, such as luminance, life, resolution, etc., can be improved.

A discharge voltage restraining effect can be recognized even when the coat member is provided only on the rear substrate side to cover a region that faces a region outside phosphor layers. Thus, the insulating coat in the region outside a phosphor screen 6 is provided in any of three fashions; on the front substrate side only, on the rear substrate side only, or on either of these sides.

Various regions may be set to be covered. An effect can be expected even if covered regions on the front substrate and the rear substrate are not the same. For example, the common electrode portion and the connecting resistors of the front substrate may be covered. In this case, only a position corresponding to the common electrode is covered on the rear substrate side. If a desired position cannot be attained owing to various restrictions on design, it is necessary only that the electric discharge restraining effect be able to be enhanced to a necessary level.

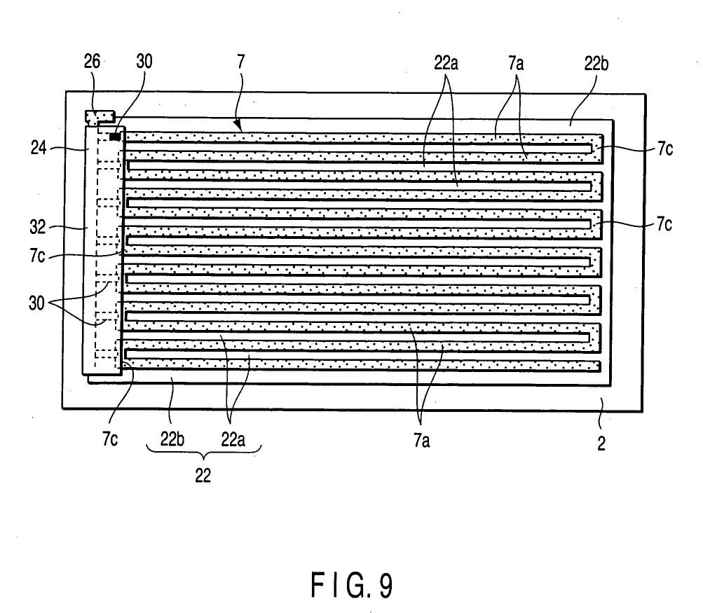

The metal back layer 7 is not limited to the aforesaid strip-shaped configuration, but may be in a zigzag pattern that is obtained by folding back an elongate belt-shaped electrically conductive thin film into the shape of a bellows, as shown in FIG. 9. In the present invention, the divided metal back layer is used as a concept that includes a patterned metal back layer having such a zigzag pattern or the like. The metal back layer 7 in the zigzag pattern has a large number of divided regions 7a in the shape of elongate stripes that are arranged with given gaps and extend parallel to one another and a plurality of turn regions 7c at which end portions of the adjacent divided regions are coupled together.

On the phosphor screen 6, the divided regions 7a and the turn regions 7c that serve as high-resistance regions are provided overlapping phosphor layers R, G, B. Those regions of the metal back layer 7 which overlap a light shielding layer 22 form gaps, through which most of the light shielding layer 22 is exposed. Respective one ends of the divided regions 7e and the turn regions 7c that couple the one end side are connected electrically to a common electrode 24 through connecting resistors 30. The common electrode 24 and the connecting resistors 30 are covered by a coat member 32.

According to the above mentioned construction, generation of electric discharge can be restrained in the region of a phosphor screen and a region outside the phosphor screen, whereby an effective measure to restrain electric discharge damage can be realized. Thus, the anode voltage can be increased, and a gap between a front substrate and a rear substrate can be narrowed, so that characteristics of a display device, such as luminance, life, resolution, etc., can be improved.

What is claimed is:

1. An image display device comprising:
a front substrate having a phosphor screen including phosphor layers and a light shielding layer, a metal back layer lapped on the phosphor screen and having a plurality of divided regions spaced from one another, a common electrode which applies voltage to the metal back layer, connecting resistors which connect the common electrode and the plurality of divided regions of the metal back layer, and a coat which has a sheet resistance higher than the sheet resistance of the connecting resistors and covers the common electrode; and
a rear substrate opposed to the front substrate and having a plurality of electron emitting elements which emit electrons toward the phosphor screen.

2. The image display device according to claim 1, wherein the coat of the front substrate covers the common electrode and the connecting resistors.

3. The image display device according to claim 1, which comprises a plurality of wires which are provided on the rear substrate and drive the electron emitting elements and a coat which covers those ones of the wires which are situated in a region opposite to the common electrode, and wherein the coat which covers the wires has a sheet resistance of 1E7 Ω/□ or more.

4. The image display device according to claim 3, wherein the coat of the rear substrate covers those ones of the wires which are situated in regions opposite to the common electrode and the connecting resistors.

5. The image display device according to claim 1, wherein the plurality of divided regions of the metal back layer are formed in the shape of an elongate stripe each and arranged with gaps therebetween, and one end of each of the divided regions is connected to the common electrode through each corresponding connecting resistor.

6. An image display device comprising:
a front substrate having a phosphor screen including a phosphor layer and a light shielding layer, a metal back layer lapped on the phosphor screen and having a plurality of divided regions spaced from one another, a common electrode which applies voltage to the metal back layer, and connecting resistors which connect the common electrode and the plurality of divided regions of the metal back layer;
a rear substrate opposed to the front substrate and having a plurality of electron emitting elements which emit electrons toward the phosphor screen, a plurality of wires connected to the electron emitting elements, and a coat which covers those ones of the wires which are situated in a region opposite to the common electrode and has a sheet resistance of 1E7 Ω/□ or more.

7. The image display device according to claim 6, wherein the coat covers those ones of the wires which are situated in regions opposite to the common electrode and the connecting resistors.
